(19) United States
(12) Patent Application Publication
(10) Pub. No.: US 2021/0268823 A1
(43) Pub. Date: Sep. 2, 2021

(54) POLYMER BASED COMPOSITE SUITABLE FOR BOTH LASER MARKING AND PRINTING BY DYE DIFFUSION THERMAL TRANSFER PRINTING

(71) Applicants: Evonik Specialty Chemicals (Shanghai) Co., Ltd., Shanghai (CN); Evonik Operations Gmbh, Essen (DE)

(72) Inventors: Huifeng Yu, Shanghai (CN); Jianmin Yang, Shanghai (CN); Fei Teng, Shanghai (CN); Florian Hermes, Haltern am See (DE); Chenyu Ye, Shanghai (CN)

(73) Assignees: Evonik Specialty Chemicals (Shanghai) Co., Ltd., Shanghai (CN); Evonik Operations Gmbh, Essen (DE)

(21) Appl. No.: 17/250,267

(22) PCT Filed: Jun. 29, 2018
(86) PCT No.: PCT/CN2018/093801

§ 371 Date: Dec. 22, 2020

(51) Int. Cl. B41M 5/52; B32B 27/08; B32B 7/12; B32B 27/34; B32B 23/08; B32B 37/18; B32B 27/20; C08L 77/06; C08L 77/02

(52) U.S. Cl. CPC B41M 5/5218; C08L 2205/025; B32B 7/12; B32B 27/34; B32B 23/08; B32B 37/182; B32B 27/20; B41M 5/5263; C08L 77/06; C08L 77/02; B32B 2250/02; B32B 2250/03; B32B 2250/24; B32B 2264/108; B32B 2307/414; B32B 2307/402; B32B 2307/412; B32B 2307/75; B32B 2425/00; B41M 2205/02; B32B 27/08

(57) ABSTRACT

A polymer based composite contains (a) a polyamide component, (b) a (co)-polyamide based on ether units and amide units, and (c) carbon black. It has been found that (1) the (co)-polyamide (b) offers sufficient absorbency for the printing ink, and (2) the selection of the polyamide component, the (co)-polyamide, and the amount of the carbon black result in both sufficient transparency and sufficient absorption centers for the laser energy. A moulded article can be made of the polymer based composite. A layered structure can be made containing at least one layer made of the polymer based composite and a security and/or valuable document containing the layered structure.

### FIELD OF THE INVENTION

The present invention relates to a polymer based composite which is suitable for both laser marking and printing by means of dye diffusion thermal transfer printing.

### BACKGROUND

Inscribing plastics by means of laser engraving is widely used in security documents, in particular identification documents such as passports, ID cards or credit cards. The black-and-white personalization of cards by means of laser engraving, that is to say the application of lettering or images such as black-and-white photographs, is generally known. Personalization by means of laser engraving is generally distinguished in particular by its high security against forgery. The (text) image is formed on the inside of the card, so that it is not possible to remove the (text) image and produce a new (text) image.

At present, the most commonly used plastics in laser engraving identification cards and security documents are polycarbonates. For example, US2012001413 describes a layered structure having laser engravability wherein the layer for laser engraving is polycarbonate based.

In the production of security and/or valuable documents, in particular identification documents in the form of cards (ID cards), there is also the need for colored personalization of the documents. One of these consists of the use of dye diffusion thermal transfer printing of colored information on substrates of plastic, since this offers the advantage of a high image accuracy in colored printing, and images and information personalized on the spot can also be printed in good quality by this means.

Diverse plastics materials have already been discussed in the literature for printability by means of dye diffusion thermal transfer printing. Thus, according to Stark et al., Polymer 40 (1999) 4001-4011 diverse plastics are suitable as materials for dye acceptor coatings, but without concrete preferences being mentioned there. WO 98/07573 A1 discloses dye acceptor coatings of polyvinyl chloride copolymers. In Shearmur et al., Polymer 37, vol. 13 (1996) 2695-2700, diverse polyesters and polyvinyl butyral are investigated as possible materials for dye acceptor layers. U.S. Pat. No. 5,334,573 investigates suitable materials with the aim of avoiding sticking of the dye acceptor sheets to the dye donor sheets. EP 673 778 B1 discloses thermotransfer receiver films with a coated, metallized polymer surface as the receiver film. Plastics, such as PVC, vinyl acetate/vinyl chloride copolymers, polyvinylidene acetals, PMMA and silicone surfaces based on polymers are mentioned here in particular for the receiver layer.

When substrates of plastic are used for such printing, however, there is the problem that the surface of the substrate of plastic must offer an adequate absorbency for the printing ink, without the image sharpness and color intensity thereby being impaired. In many cases, the color intensity of the printed images in particular is in need of improvement.

For the moment, there is no commercial solution for one material which suitable for both laser marking and printing by means of dye diffusion thermal transfer printing.

### OBJECT

It was an object of the present invention, via development and formulation of suitable polymers, to develop a composite which is suitable for both laser marking and printing by means of dye diffusion thermal transfer printing.

A particular object of the present invention was that the composite can be widely used in security documents, in particular identification documents such as passports, ID cards or credit cards.

Another object was to develop a layered structure comprising the composite which is more flexibility, durability and environmentally friendly, than the prior art.

Other objects not explicitly mentioned will be apparent from the entirety of the description, claims, and examples below.

### SUMMARY OF THE INVENTION

The objects are achieved by a polymer based composite, comprising (a) a polyamide component, (b) a (co)-polyamide based on ether units and amide units, and (c) carbon black.

Within the scope of the invention, ppm means ppm by weight, unless indicated otherwise.

Surprisingly, it has been found that

(1) the (co)-polyamide (b) offers sufficient absorbency for the printing ink, thus the polymer based composite can be printed on by means of dye diffusion thermal transfer printing, and a good color intensity of the printed image is achieved, and
(2) the selection of the polyamide component and the (co)-polyamide and the amount of the carbon black result in both sufficient transparency and sufficient absorption centers for the laser energy, such that desired quality (that is to say sharpness and resolution) of laser marking is achieved.

The present invention also provides use of the polymer based composite

(1) as material for producing mouldings which are marked with the aid of lasers, and/or
(2) as the ink receiver or printing medium in dye diffusion thermal transfer printing.

The present invention further provides the moulded article made of the polymer based composite.

The present invention further provides a layered structure comprising:

(A) at least one Layer (A) comprising a thermoplastic plastic, and
(B) at least one Layer (B) produced from the polymer based composite as above described.

Other advantages of the layered structure comprising the polymer based composite of the present invention are more durability, for example with respect to polycarbonate, and more environmentally friendly with respect to PVC.

The present invention further provides a process for the production of the layered structure of present invention, comprising bonding the various films of plastic to one another by a process selected from lamination, coextrusion, in mould labeling, and direct gluing.

The present invention further provides a security and/or valuable document, comprising the layered structure of the present invention.

### DETAILED DESCRIPTION OF THE INVENTION

The polymer based composite comprises

(a) a polyamide component (a),
(b) a (co)-polyamide based on ether units and amide units (b), and
(c) carbon black.

Preferably, the polyamide component (a) comprises based on the total weight thereof at least 50 wt %, more preferably at least 80 wt %, and most preferably 95 wt % a polyamide selected from the group consisting of:

(a1) a linear aliphatic polyamide of the AB type having 10-12 carbon atoms, produced by polymerizing lactams having from 10-12 carbon atoms in the monomer unit or by polycondensing a ω-aminocarboxylic acids having from 10-12 carbon atoms in the monomer unit,
(a2) a linear aliphatic polyamide of the AABB type, produced by polycondensing diamines having 6-14 carbon atoms in the monomer units and dicarboxylic acids having 9-14 carbon atoms in the monomer unit,
(a3) a cycloaliphatic polyamide, produced by polycondensing a cycloaliphatic diamine having 10-20 carbon atoms in the monomer units and an aliphatic dicarboxylic acid having 8-18 carbon atoms in the monomer units, optionally further produced by a lactam having 6-14 carbon atoms or a linear aliphatic ω-aminocarboxylic acid having 6-14 carbon atoms,
(a4) a semi-aromatic polyamide based on an cycloaliphatic diamine having 10-20 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms,
(a5) a semi-aromatic polyamide based on an aliphatic diamine having 2-12 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms, and the compound thereof as well as the (co)-polymer thereof.

Polyamides (a1) to (a5) are suitable polyamide components. Preferred polyamides are (a1), (a2), or (a3), more preferably (a1) or (a3) and especially (a1).

The linear aliphatic polyamide (a1) has on average from 8 to 14 carbon atoms in the individual monomer units. Said linear aliphatic polyamide (a1, a2) is producible from a combination of a diamine and a dicarboxylic acid, from an ω-aminocarboxylic acid and/or the corresponding lactam. The monomer units in question are therefore the units which derive from the lactam, ω-aminocarboxylic acid, diamine or dicarboxylic acid. Suitable linear aliphatic polyamides (a1, a2) further include (co)-polyamides which comprise diamines having 6-14 carbon atoms in the monomer unit and dicarboxylic acids having 9-14 carbon atoms in the monomer unit (e.g. PA12/1012).

The following polyamides (a1), (a2) are suitable by way of example: PA79, PA610, PA99, PA810, PA612, PA10, PA1010, PA812, PA614, PA11, PA1012, PA1210, PA913, PA139, PA814, PA12, PA1212, PA1113, PA1014, PA1410, and compounds as well as (co)-polyamides based on these systems. Alternatively, the polyamides (a2) can be PA88, PA97, PA106, PA108, PA126, PA128, PA146, PA148, PA616, PA816, PA618 and compounds as well as (co)-polyamides based on these systems.

Commercially available products of the linear aliphatic polyamide (a1) are for example PA12 products under the tradename of VESTAMID® L, commercially available from Evonik Resource Efficiency GmbH, such as VESTAMID® L2101F and VESTAMID® L1940.

Suitable cycloaliphatic diamines of the cycloaliphatic polyamide (a3) and the semi-aromatic polyamide (a4) are for example bis-(4-amino-3-methyl-cyclohexyl)-methane (MACM), bis-(4-amino-cyclohexyl)-methane (PACM), bis-(4-amino-3-ethyl-cyclohexyl)-methane (EACM), bis-(4-amino-3,5-dimethyl-cyclohexyl)-methane (TMDC), 2,2-(4,4′-diaminodicyclohexyl)propane (PACP), and the mixtures thereof.

Suitable aliphatic dicarboxylic acids are for example sebacic acid, undecanedioic acid, dodecanedioic acid, tridecanedioic acid (brassylic acid), tetradecanedioic acid, pentadecanedioic acid, hexadecanedioic acid, and the mixtures thereof.

Suitable aromatic dicarboxylic acids are for example isophthalic acid, terephthalic acid, and naphthalene dicarboxylic acid, and the mixtures thereof.

The cycloaliphatic polyamide (a3) is typically produced from the cycloaliphatic diamine and the dicarboxylic acid and the semi-aromatic polyamide (a4) is typically produced from the cycloaliphatic diamine and the aromatic dicarboxylic acid by polycondensation in the melt according to known processes. However, derivatives thereof may also be employed, for example the diisocyanate which derives from the cycloaliphatic diamine, or a dicarboxylic diester which derives from the dicarboxylic acid.

Preferably, the cycloaliphatic polyamide (a3) is selected from the group consisting of MACM10, MACM11, MACM12, MACM13, MACM14, MACM16, PACM10, PACM11, PACM12, PACM13, PACM14, PACM16, TMDC10, TMDC11, TMDC12, TMDC13, TMDC14, TMDC15, TMDC16, and compounds as well as (co)-polyamides based on these systems.

Preferably, the semi-aromatic polyamide (a4) is selected from the group consisting of MACMI/12, MACMT/12, PACMI/12, PACMT/12, and compounds as well as (co)-polyamides based on these systems.

The cycloaliphatic diamine may exist as a mixture of isomers. For example, PACM may exist as a mixture of cis, cis, cis, trans and trans, trans isomers. It is commercially available with various isomer ratios. In one preferred embodiment the trans, trans isomer content of the PACM or of the employed derivative thereof is 30-70% and particularly preferably from 35-65%.

More preferably, the cycloaliphatic polyamide (a3) or the semi-aromatic polyamide (a4) is transparent with a haze of less than 3% and particularly preferably of less than 2% where both properties are determined to ASTM D1003 on injection moulded test specimens of 2 mm in thickness.

Commercially available products of the cycloaliphatic polyamide (a3) are for example PA PACM12 products under the tradename of TROGAMID®, commercially available from Evonik Resource Efficiency GmbH, such as TROGAMID® CX7323 and TROGAMID® CX9704.

The semi-aromatic polyamide (a5) is based on an aliphatic diamine having 2-12 carbon atoms and an aromatic dicarboxylic acid having 8-18 carbon atoms.

Suitable aliphatic diamines are for example ethylenediamine, butanediamine, pentanediamine, hexamethylenediamine, octanediamine, methyloctanediamine, nonanediamine, decanediamine, undecanediamine, dodecanediamine, trimethylhexamethylenediamine, methylpentanediamine, and the mixtures thereof.

Suitable aromatic dicarboxylic acids are for example isophthalic acid, terephthalic acid, and naphthalene dicarboxylic acid, and the mixtures thereof.

Preferably, the semi-aromatic polyamide (a5) is selected from the group consisting of PA61/6T, PA 10T/6T, PA6T/61 and PA6-3-T and compounds as well as (co)-polyamides based on these systems.

Commercially available products of the semi-aromatic polyamide (a5) are for example PA6-3-T products under the tradename of TROGAMID® and PA61/6T products under the tradename of VESTAMID® HTplus, both commercially available from Evonik Resource Efficiency GmbH, such as TROGAMID® T5000 and VESTAMID® HTplus M5000.

The (co)-polyamide (b) is based on ether units and amide units.

Preferably, the (co)-polyamide (b) is selected from PEBA (co)-polymers composed of blocks of amide units and of sequences of ether units.

PEBA (co)-polymers are sequential multi-block (co)-polymers and belong to the specific category of polyetheresteramides or polyetheramides, when they result from the copolycondensation of polyamide sequences comprising reactive carboxyl ends with polyether sequences comprising reactive ends which are polyether polyols(polyether diols), the bonds between the polyamide blocks and the polyether blocks being ester bonds, or else to the category of polyetheramides or polyether-block-amides, when the polyether sequences comprise amine ends. Both the two above families are included in the definition of the (co)-polyamide (b).

The ether units or sequences of the (co)-polyamide (b) result, for example, from at least one polyalkylene ether polyol, in particular a polyalkylene ether diol, preferably chosen from polyethylene glycol (PEG), polypropylene glycol (PPG), polytrimethylene glycol (PO3G), polytetramethylene glycol (PTMG) and their blends or their (co)-polymers.

The polyether blocks can also comprise, as indicated above, polyoxyalkylene sequences comprising NH₂ chain ends, it being possible for such sequences to be obtained by cyanoacetylation or reductive amination of α,ω-dihydroxylated aliphatic polyoxyalkylene sequences referred to as polyether diols. More particularly, it will be possible to use Elastamine® grades (for example, Elastamine® RP405, RP2005, RE900, RE2003, RTP 542, commercial products from Huntsman. See also Patents JP 2004346274, JP 2004352794 and EP1482011).

The amide units or blocks of the (co)-polyamide (b) can in particular be residues of linear aliphatic monomers, such as:
linear aliphatic diamines which can be selected from linear aliphatic diamines having 2-14 carbon atoms, such as 1,4-tetramethylenediamine, 1,6-hexamethylene-diamine, 1,9-nonamethylenediamine and 1,10-decamethylenediamine; or cycloaliphatic diamines, most preferably based on 1,4-disubstituted cyclohexane backbones.
aliphatic dicarboxylic acids which can be selected from aliphatic dicarboxylic acids having 6-36 carbon atoms, preferably 9-18 carbon atoms, in particular 1,10-decanedicarboxylic acid (sebacic acid), 1,12-dodecanedicarboxylic acid, 1,14-tetradecanedicarboxylic acid and 1,18-octadecanedicarboxylic acid;
lactams, such as caprolactam, oenantholactam and lauryllactam; and α,ω-aminocarboxylic acids, such as aminocaproic acid, 7-aminoheptanoic acid, 11-aminoundecanoic acid or 12-aminododecanoic acid; and
aromatic or cycloaliphatic diacids, most preferably based on 1,4-disubstituted cyclohexane backbones.

Mention may be made, as PEBA (co)-polymers which are particularly preferred for the (co)-polyamide (b) of those composed of amide units which are residues of linear aliphatic monomers and of polyether sequences of PTMG, PPG or PEG type, it being possible for the residues of linear aliphatic monomers in particular to be residues of a diamine and of a diacid.

For the PEBAs which can be used as the (co)-polyamide (b), the number-average molecular weight of the polyimide blocks is preferably 500-12,000 g/mol, more preferably 2,000-6,000 g/mol; and the number-average molecular weight of the sequences of ether units is preferably 200-4,000 g/mol, preferably 300-1,100 g/mol.

The polyamide block units can represent 50-95% by weight of the (co)-polyamide (b).

The (co)-polyamide (b) includes amide units for which the number of carbons per amide is on average at least equal to 9, and/or the amide units of the (co)-polyamide (b) represent 50-95% by weight of the (co)-polyamide (b).

Commercially available products of the (co)-polyamide (b) are for example PEBA (poly-ether-block-amide) products under the tradename of VESTAMID®, commercially available from Evonik Resource Efficiency GmbH, such as VESTAMID® E40-53, E62-53, E55-53, E47-53, and E58-S4.

Preferably, the plastic material comprises based on the total weight thereof: 5-95%, more preferably 20-80%, most preferably 30-70% of the polyamide component (a), and 5-95%, more preferably 20-80%, most preferably 30-70% of the (co)-polyamide (b).

The polymer based composite of the present invention comprises carbon black as a laser-sensitive additive.

Preferably, the carbon black is present in the polymer based composite in an amount of 50-300 ppm, more preferably 100-200 ppm, even more preferably 120-180 ppm, based on the total weight of the polymer based composite.

Preferably, the carbon black has an average particle size of 10 nm-10 μm, and more preferably of 50 nm-2 μm.

Commercially available products of the carbon black are for example carbon black products under the tradenames Printex® and Lamp black both commercially available from Orion Engineered Carbons GmbH, such as Lamp black 101.

The polymer based composite may include other ingredients, such as stabilizers, lubricants, colorants, plasticizers, nucleants, antioxidants, impact modifiers and UV absorbers, depending on the desired performance without impairing the transparency significantly. Preferably, these ingredients are added in low amounts, typically up to 20 wt %, more preferably up to 5 wt % of the total composite.

The carbon black is premixed with polyamide component (a) to produce masterbatch granules.

The polymer based composite can be produced for example in a twin screw compounding extruder at conventional processing temperatures for the polyamide component (a), the (co)-polyamide (b) and the masterbatch granules.

The present invention further provides the moulded article made of the polymer based composite.

Preferably, the moulded article is in the form of a film.

The layered structure of the present invention comprises:

(A) at least one Layer (A) comprising a thermoplastic plastic, and
(B) at least one Layer (B) made of the polymer based composite as above described.

There is no limit to the thermoplastic plastic of Layer (A), examples of which include cellulose acetate propionate, cellulose acetate butyrate, polyesters, polyamides, polycarbonates, polyimides, polyolefins, polyvinylchlorides, polyvinylacetals, polyethers and polysulphonamides. Preferably, the thermoplastic plastic of Layer (A) is a polyamide identical to the polyamide of Layer (B) for compatibility reason.

Preferably, Layer (A) is a white or translucent layer.

A white or translucent Layer (A) is preferably a layer colored white with pigments or having a filler content of fillers. Such layers, preferably layers of plastic, colored white or having a filler content of fillers preferably comprise titanium dioxide, zirconium dioxide, barium sulfate or glass fibres as pigments and/or fillers. The pigments or fillers mentioned are preferably added to the plastics before the shaping to give the Layer (A), which can be carried out, for example, by extrusion or coextrusion, in amounts of 2-60 wt %, particularly preferably 10-40 wt %, based on the total weight of pigment or filler and plastics material.

Preferably, the layered structure comprise at least three layers wherein Layer (A) is between two layers (B).

Such an at least three-layered structure has the advantage that, when it is incorporated into a security document, it is not necessary to ensure that the Layer (B) (which is printable by means dye diffusion thermal transfer printing) is oriented outwards.

The layered structure of the present invention can have one or more further layer(s) comprising at least one thermoplastic plastic between the Layer (A) and the Layer(s) (B). These can be translucent or white layers, transparent layers or colored layers.

The layered structure of the present invention can be produced, for example and preferably, by means of lamination, coextrusion, in mould labeling, and direct gluing of the layers that are present.

The layered structure according to the invention is particularly preferably suitable for identification and/or valuable documents in the form of bonded or laminated layers in the form of plastics cards.

The layered structure of the present invention, is outstandingly suitable as a component of security documents, preferably identification documents, which are to be marked with the aid of lasers and/or printed by means dye diffusion thermal transfer printing.

Accordingly, the invention further provides an identification and/or valuable document, comprising at least the layered structure of the present invention. The identification and/or valuable documents are for example identification cards, passports, driving licenses, credit cards, bank cards, cards for controlling access or other identity documents, etc.

The identification and/or valuable document can further comprise additional layers which provide protection against UV radiation, protection against mechanical and chemical damage etc.

### DRAWINGS

FIGS. 1-6 are the scanned images of samples of sandwich structures (EC1-EC6) after both laser engraving and D2T2 printing. Each of FIGS. 1-6 comprises two portraits of the same woman and two lines of letters. The left portraits are printed by D2T2. The right portraits and the letters are inscribed by laser engraving.

### EXAMPLES

### Material

TROGAMID® CX7323: PA PACM12, a polyamide produced from bis(4-aminocyclohexyl)methane and dodecanedioic acid; ηᵣₑₗ=1.8; commercially available from Evonik Resource Efficiency GmbH;

VESTAMID® L2101F: a base-unit PA12 with ηᵣₑₗ=2.2, commercially available from Evonik Resource Efficiency GmbH;

VESTAMID® E58-S4: a polyether-block-amide which is a (co)-polymer consisting of PA12 segments and polyether segment with ηᵣₑₗ=1.8. (PA12 elastomer), commercially available from Evonik Resource Efficiency GmbH;

Ti-Pure™ R-105: Titanium dioxide, commercially available from the Chemours Company;

Ultranox® 626: Phosphite commercially available from Addivant Germany GmbH;

Lamp black 101: Carbon black with an average particle of 95 nm, commercially available from Orion Engineered Carbons GmbH.

### Preparation of Masterbatches

Masterbatch granules having the compositions and the weight percentages as indicated in the following table 1 were prepared in a twin-screw compounding extruder (Coperion ZSK-26mc) at conventional processing temperatures for TROGAMID® CX7323 of 260-300° C. or for VESTAMID® L2101F of 250-300° C.

TABLE 1
Masterbatch

| | MB1 | MB2 |
|---|---|---|
| TROGAMID ® | 99.88% | |
| CX7323 | | |
| VESTAMID ® | | 99.88% |
| L2101F | | |
| Lampblack 101 | 0.12% | 0.12% |

### Preparation of the Polymer Based Composites and the Films Made Thereof

Polyamide compounds having the compositions and the weight percentages of the examples (EA1-EA2 and EB1-EB6) as indicated in the following table 2 were prepared in a twin-screw compounding extruder (Coperion ZSK-26mc) at conventional processing temperatures for TROGAMID® CX7323 of 260-300° C. or for VESTAMID® L2101F of 250-300° C.

The installation used consisted of an extruder (Dr. Collin E20M) with a screw of 20 mm diameter (D) and length of 25×D and T-die head with 25 mm slot width.

The films were prepared according to the following process:

The granules of the polyamide compounds were dried and fed into the hopper. The granules were then melted and in situ extruded out from the die. The melt of the polymer compounds came out from the die and dropped at the polishing calender. Final shaping and cooling of the films took place on the polishing calender consisting of three rolls. The films made of the polymer compounds with a thickness of 0.1 mm were obtained.

TABLE 2
Recipe of polyamide compounds the films made thereof

| | EB1 | EB2 | EB3 | EB4 | EBS | EBG | EA1 | EA2 |
|---|---|---|---|---|---|---|---|---|
| TROGAMID ® | 35% | 42.5% | 65% | | | | 84.8% | |
| CX7323 | | | | | | | | |
| VESTAMID ® | | | | 35% | 42.5% | 68% | | 84.8% |
| L2101F | | | | | | | | |
| VESTAMID ® | 50% | 50% | 20% | 50% | 50% | 17% | | |
| E58-S4 | | | | | | | | |
| Masterbatch | 15% | 7.5% | 15% | | | | | |
| of MB1 | | | | | | | | |
| Masterbatch | | | | 15% | 7.5% | 15% | | |
| of MB2 | | | | | | | | |
| Ti-Pure ™ | | | | | | | 15% | 15% |
| R-105 | | | | | | | | |
| Ultranox ® 626 | | | | | | | 0.2% | 0.2% |

Matrix

| | | | | | | | | |
|---|---|---|---|---|---|---|---|---|
| TROGAMID ® | 50% | 50% | 80% | | | | 100% | |
| CX7323 | | | | | | | | |
| VESTAMID ® | | | | 50% | 50% | 83% | | 100% |
| L2101F | | | | | | | | |
| VESTAMID ® | 50% | 50% | 20% | 50% | 50% | 17% | | |
| E58-S4 | | | | | | | | |

Fillers

| | | | | | | | | |
|---|---|---|---|---|---|---|---|---|
| Carbon black | 180 | 90 | 180 | 180 | 90 | 180 | | |
| content | | | | | | | | |
| (Ppm) | | | | | | | | |
| White | | | | | | | 15% | 15% |
| pigment | | | | | | | | |
| content | | | | | | | | |

### Preparation of Samples of Sandwich Structure

Sandwich structures having two outer layers and five core layers as following were prepared: two outer layers: a film of EB1-EB6;

five core layers: a film of EA-EA2 which has the same polyamide as the outer layers.

The films of the individual layers of the sandwich structure were stacked in a mold for lamination. The mold was then transferred to a plate press machine (Collin P 300P). The films were heated to 160-200° C. for 15 min, then laminated under a pressure of 5-35 bar and cooled to 23° C. Samples of the sandwich structure had a thickness of 0.78-0.82 mm were obtained and then cut to have a dimension of 53.98 mm×85.60 mm as ID cards. The final structure of the samples is indicated in the following Table 3.

TABLE 3
The sandwich structures

| | EC1 | EC2 | EC3 | EC4 | EC5 | EC6 |
|---|---|---|---|---|---|---|
| Outer layers | EB1 | EB2 | EB3 | EB4 | EB5 | EB6 |

| | | |
|---|---|---|
| Core layers | EA1 | EA2 |

### Printing of the Samples of the Sandwich Structure by Dye Diffusion Thermal Transfer Printing (D2T2 Printing)

Printing experiments were carried out on the samples of the sandwich structure on an installation from Datacard® CD800 Card Printer with the following parameters:

Colour ribbon: Datacard 535000-003 YMCKT Colour Ribbon

Resolution: 300×600 dpi

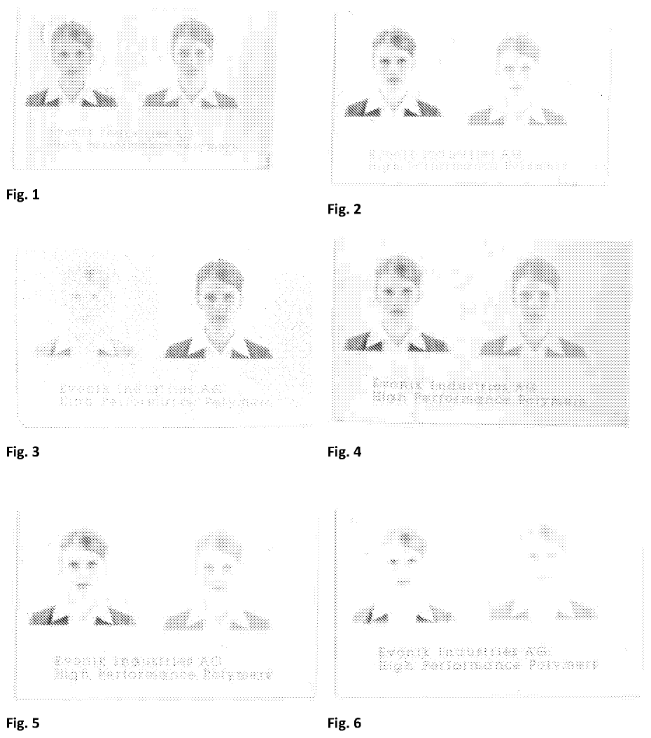

A coloured image of a woman's portrait was printed on the left part of one outer layer of the sandwich structure. Image quality was assessed. The result is indicated in FIGS. 1-6 and Table 4.

TABLE 4
Performance of D2T2 printing on the examples

| | EC1 | EC2 | EC3 | EC4 | EC5 | EC6 |
|---|---|---|---|---|---|---|
| Image | +++ | +++ | + | +++ | +++ | ++ |
| quality | | | | | | |

It can be seen that the image quality can be improved by the polyether-block-amide (e.g. VESTAMID® E58-S4) added to the plastic material.

Image quality is graded as following:

Poor (−): outline of the portrait is difficult to recognize, colours are barely transferred on the substrate from the ribbon;

Low (+): the outline of the portrait can be reorganized but without clearly defined facial features;

Medium (++): the outline of the portrait can be reorganized, facial features can be clearly observed but with some colour distortion;

High (+++): the outline of the portrait can be reorganized, facial features can be clearly observed with high colour intensity.

### Laser Engraving of the Samples of the Sandwich Structure

Laser engraving was carried out on the samples of EC1-EC6 on a TruMark 3130 (TRUMPF) machine with the following parameters:

Laser medium: Nd: YVO₄

### Wavelength: 1064 nm

### Power: 10.5 W

### Voltage: 220 V

### DPI: 600

### Frequency: 45000 Hz

In the laser engraving, a black-and-white portrait of a woman and letters were inscribed the right part and bottom part respectively in one outer layer of the individual samples of EC1-EC6. As also indicated in FIGS. 1-6, an excellent contrast and very good graduation of the greyscales were achieved in EC1-EC6.

1: A polymer based composite, comprising:
(a) a polyamide component (a),
(b) a (co)-polyamide (b) based on an ether unit and an amide unit, and
(c) carbon black.

2: The polymer based composite of claim 1, wherein
the polymer based composite comprises, based on the total weight thereof,
5-95% of the polyamide component (a), and
5-95% of the (co)-polyamide (b).

3: The polymer based composite of claim 1, wherein
the (co)-polyamide (b) is selected from the group consisting of poly-ether-block-amide (PEBA) (co)-polymers comprising blocks of amide units and sequences of ether units.

4: The polymer based composite of claim 1, wherein
the ether units of the (co)-polyamide (b) result from at least one polyalkylene ether polyol, and
wherein the (co)-polyamide (b) comprises amide units which are residues of linear aliphatic monomers and polyether sequences of a PTMG, PPG or PEG type.

5: The polymer based composite of claim 3, wherein
a number-average molecular weight of the polyamide blocks is 500-12,000 g/mol, and/or
a number-average molecular weight of the sequences of ether units is 200-4,000 g/mol.

6: The polymer based composite of claim 3, wherein
the (co)-polyamide (b) includes amide units for which the number of carbons per amide is on average at least equal to 9, and/or
the amide units of the (co)-polyamide (b) represent 50-95% by weight of the (co)-polyamide (b).

7: The polymer based composite of claim 1, wherein
the polyamide component (a) is selected from the group consisting of:
(a1) a linear aliphatic polyamide of the AB type having 10-12 carbon atoms, produced by polymerizing a lactam having from 10-12 carbon atoms in the monomer unit or by polycondensing a ω-aminocarboxylic acid having from 10-12 carbon atoms in the monomer unit,
(a2) a linear aliphatic polyamide of the AABB type, produced by polycondensing a diamine having 6-14 carbon atoms in the monomer unit and a dicarboxylic acid having 9-14 carbon atoms in the monomer unit,
(a3) a cycloaliphatic polyamide, produced by polycondensing a cycloaliphatic diamine having 10-20 carbon atoms in the monomer unit and an aliphatic dicarboxylic acid having 8-18 carbon atoms in the monomer unit, optionally further produced by a lactam having 6-14 carbon atoms or a linear aliphatic ω-aminocarboxylic acid having 6-14 carbon atoms,
(a4) a semi-aromatic polyamide based on a cycloaliphatic diamine having 10-20 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms,
(a5) a semi-aromatic polyamide based on an aliphatic diamine having 2-12 carbon atoms and an aromatic dicarboxylic acid having 8-18 carbon atoms, optionally further produced by a lactam having 6-14 carbon atoms or a linear aliphatic ω-aminocarboxylic acid having 6-14 carbon atoms,
and a compound or a (co)-polymer thereof.

8: The polymer based composite of claim 1, wherein
the linear aliphatic polyamide (a1) or (a2) is selected from the group consisting of: PA79, PA610, PA99, PA810, PA612, PA10, PA1010, PA812, PA614, PA11, PA1012, PA1210, PA913, PA139, PA814, PA12, PA1212, PA1113, PA1014, PA1410, and a compound thereof.

9: The polymer based composite of claim 1, wherein
the cycloaliphatic polyamide (a3) and the semi-aromatic polyamide (a4) are selected from the group consisting of MACM10, MACM11, MACM12, MACM13, MACM14, MACM16, PACM10, PACMI 1, PACM12, PACM13, PACM14, PACM16, TMDC10, TMDC11, TMDC12, TMDC13, TMDC14, TMDC15, TMDC16, MACMI/12, MACMT/12, PACMI/12, PACMT/12 and a mixture or a (co)-polyamide based on these systems.

10: The polymer based composite of claim 9, wherein
the cycloaliphatic polyamide (a3) and the semi-aromatic polyamide (a4) are selected from the group consisting of PACM10, PACM11, PACM12, PACM13, PACM14, and PACM16, having a content of trans, trans isomer of 30-70%.

11: The polymer based composite of claim 7, wherein
the cycloaliphatic polyamide (a3) is transparent with a haze of less than 3%, where both properties are determined according to ASTM D1003 on injection moulded test specimens of 2 mm in thickness.

12: The polymer based composite of claim 1, wherein the carbon black
has a particle size of 10 nm-10 μm, and/or
is present in an amount of 50-300 ppm, based on the total weight of the polymer based composite.

13: The polymer based composite of claim 1, wherein
the composite further comprises up to 20% by weight, of one or more additional ingredients, selected from the group consisting of: stabilizers, lubricants, colorants, plasticizers, nucleants, antioxidants, impact modifiers and UV absorbers.

14: A moulded article made of the polymer based composite of claim 1.

15: A method for producing a moulding, the method comprising:
moulding the polymer based composite of claim 1 to obtain a moulding which can be marked with the aid of a laser.

16: A layered structure, comprising:
(A) at least one Layer (A) comprising a thermoplastic plastic, and
(B) at least one Layer (B) produced from the polymer based composite of claim 1.

17: The layered structure of claim 16, wherein
the thermoplastic plastic of Layer (A) is selected from cellulose acetate propionate, cellulose acetate butyrate, polyesters, polyamides, polycarbonates, polyimides, polyolefins, polyvinylchlorides, polyvinylacetals, polyethers and polysulphonamides.

18: The layered structure of claim 16, wherein
Layer (A) is a white or translucent layer, and/or
Layer (A) is between two Layers (B), and/or
between Layer (A) and the Layer(s) (B), the layered structure has at least one further layer comprising at least one thermoplastic plastic.

19: A process for the production of the layered structure of claim 16, the process comprising:
bonding films of plastic to one another by a process selected from the group consisting of lamination, coextrusion, in mould labeling, and direct gluing.

20: A security document and/or valuable document, comprising:
the layered structure of claim 16.
